(19) United States
(12) Patent Application Publication
(10) Pub. No.: US 2018/0222482 A1
(43) Pub. Date: Aug. 9, 2018

(54) VEHICLE CONTROL APPARATUS, VEHICLE CONTROL METHOD, AND VEHICLE CONTROL PROGRAM

(71) Applicant: HONDA MOTOR CO., LTD., Tokyo (JP)

(72) Inventors: Daichi Kato, Utsunomiya-shi (JP); Atsushi Ishioka, Utsunomiya-shi (JP); Akihiko Otsu, Fujimino-shi (JP); Akira Mizutani, Tokyo (JP); Kazuyuki Takahashi, Warabi-shi (JP)

(21) Appl. No.: 15/880,656

(22) Filed: Jan. 26, 2018

(30) Foreign Application Priority Data
Feb. 3, 2017 (JP) 2017-018638

(51) Int. Cl. B60W 30/18; B60W 40/04

(52) U.S. Cl. CPC B60W 30/18009; B60W 2550/30; B60W 2550/10; B60W 40/04

(57) ABSTRACT

A vehicle control apparatus includes: a detection part that detects a behavior of another vehicle in a region on which it is supposed that a vehicle travels in order to pass through a gate; a determination part that determines whether or not a gate is an operating gate, based on the behavior of the other vehicle which is detected by the detection part;

and a control part that performs a vehicle control so as to pass through a gate which is determined as an operating gate by the determination part.

### CROSS-REFERENCE TO RELATED APPLICATION

Priority is claimed on Japanese Patent Application No. 2017-018638, filed on Feb. 3, 2017, the contents of which are incorporated herein by reference.

BACKGROUND

### Field of the Invention

The present invention relates to a vehicle control apparatus, a vehicle control method, and a vehicle control program.

### Background

In the related art, a navigation device that performs a travel route guide in front of a gate of a tollbooth for which a lane is not set is known (for example, refer to Japanese Patent Application, Publication No. 2014-119372A). The navigation device includes an operating gate recognition part that processes a captured image and that recognizes an operating gate in a tollbooth, a gate-specifying part that specifies any one from recognized operating gates, a travel route-setting part that sets a travel route to the specified operating gate from a vehicle current position, and a travel route display part that displays the set travel route.

### SUMMARY

However, the navigation device described in Japanese Patent Application, Publication No. 2014-119372A has a possibility that, when the boundary between gates or the width of each gate cannot be recognized from the captured image, it may be impossible to specify a gate used for setting a travel route.

An object of an aspect of the present invention is to provide a vehicle control apparatus, a vehicle control method, and a vehicle control program capable of determining an appropriate gate through which a vehicle passes even when it is not possible to directly recognize the presence of a gate.

(1) A vehicle control apparatus according to an aspect of the present invention includes: a detection part that detects a behavior of another vehicle in a region on which it is supposed that a vehicle travels in order to pass through a gate; a determination part that determines whether or not a gate is an operating gate, based on the behavior of the other vehicle which is detected by the detection part; and a control part that performs a vehicle control so as to pass through a gate which is determined as an operating gate by the determination part.

(2) In the above vehicle control apparatus, when the other vehicle passes through a gate, the determination part may determine that the gate is an operating gate, and when there is a gate through which the other vehicle does not pass, the determination part may determine that the gate is not an operating gate.

(3) In the above vehicle control apparatus, in a case where a vehicle speed when the other vehicle passes through a gate exceeds a predetermined value, the determination part may determine that the gate is an operating gate, and in a case where a vehicle speed when the other vehicle passes through a gate is equal to or less than a predetermined value, the determination part may determine that the gate is not an operating gate.

(4) In the above vehicle control apparatus, the detection part may detect that the other vehicle has passed through a gate, based on information that is detected by a sensor which is provided on the vehicle.

(5) In the above vehicle control apparatus, the determination part may determine whether or not a gate is an operating gate, based on a position at which the behavior of the other vehicle is changed.

(6) In the above vehicle control apparatus, when a proceeding direction of the other vehicle is changed from a first gate to a second gate, the determination part may determine that the second gate is an operating gate and determine that the first gate is not an operating gate.

(7) The above vehicle control apparatus may further include a virtual line-setting part that sets a virtual lane used for entering the gate, based on a position of a gate, at a position before the gate, and the determination part may determine whether or not a gate that corresponds to the virtual lane is an operating gate, based on a behavior of another vehicle in the virtual lane that is set by the virtual line-setting part.

(8) In the above vehicle control apparatus, the detection part may acquire a determination result that represents whether or not a gate is an operating gate from a server or another vehicle, and the determination part may determine whether or not a gate is an operating gate, based on the determination result that is acquired by the detection part.

(9) Another aspect of the present invention is a vehicle control method that includes: detecting a behavior of another vehicle in a region on which it is supposed that a vehicle travels in order to pass through a gate; determining whether or not a gate is an operating gate, based on the behavior of the other vehicle; and performing a vehicle control so as to pass through a gate which is determined as an operating gate.

(10) Still another aspect of the present invention is a non-transitory computer-readable recording medium including a vehicle control program that causes a computer to: detect a behavior of another vehicle in a region on which it is supposed that a vehicle travels in order to pass through a gate; determine whether or not a gate is an operating gate, based on the behavior of the other vehicle; and perform a vehicle control so as to pass through a gate which is determined as an operating gate.

According to the configurations (1) to (6), (9), and (10) described above, it is determined whether or not a gate is an operating gate on the basis of the behavior of another vehicle, and therefore, it is possible to determine an appropriate gate through which a vehicle can pass even when it is not possible to directly recognize the presence of an operating gate.

According to the configurations (2), (3), and (4) described above, when another vehicle passes through a gate, it is determined that the gate is an operating gate, and therefore, it is possible to determine the operating gate that is actually used by the other vehicle as an appropriate gate through which a vehicle can pass.

According to the configurations (5) and (6) described above, it is possible to determine an appropriate gate through which a vehicle can pass on the basis of the change of the behavior of another vehicle.

According to the configuration (7) described above, it is possible to determine an appropriate gate through which a vehicle can pass on the basis of the behavior of another vehicle in a virtual lane that is set at a position closer to the vehicle than a gate.

According to the configuration (8) described above, it is possible to determine an appropriate gate through which a vehicle can pass on the basis of a determination result that is acquired from another vehicle.

### BRIEF DESCRIPTION OF THE DRAWINGS

FIG. 1 is a configuration view of a vehicle system that includes an automated driving control unit.

FIG. 2 is a view showing a state in which a relative position and an attitude of a vehicle with respect to a travel lane are recognized by a vehicle position recognition unit.

FIG. 3 is a view showing a state in which a target trajectory is generated on the basis of a target lane.

FIG. 4 is a view showing a state in which a target trajectory is generated in a tollbooth event.

FIG. 5 is a view showing an example of a process in which a valid gate and an invalid gate are determined on the basis of the behavior of another vehicle.

FIG. 6 is a view showing another example of a process in which a valid gate and an invalid gate are determined on the basis of the behavior of another vehicle.

FIG. 7 is a view showing another example of a process in which a valid gate and an invalid gate are determined on the basis of the behavior of another vehicle.

FIG. 8 is a flowchart showing the flow of a process that is performed in the tollbooth event.

FIG. 9 is a configuration view of a vehicle system of a second embodiment.

FIG. 10 is a view showing a virtual line being set for a gate in the second embodiment.

FIG. 11 is a flowchart showing the flow of a process that is performed in the tollbooth event in the second embodiment.

FIG. 12 is a view showing an example of a table in the second embodiment.

FIG. 13 is a view showing an example of a traffic information-providing system that includes a vehicle on which a vehicle system is provided.

FIG. 14 is a flowchart showing the flow of a process that is performed by the vehicle system and a traffic information management server.

### DESCRIPTION OF THE EMBODIMENTS

Hereinafter, an embodiment of a vehicle control apparatus, a vehicle control method, and a vehicle control program of the present invention will be described with reference to the drawings.

### First Embodiment

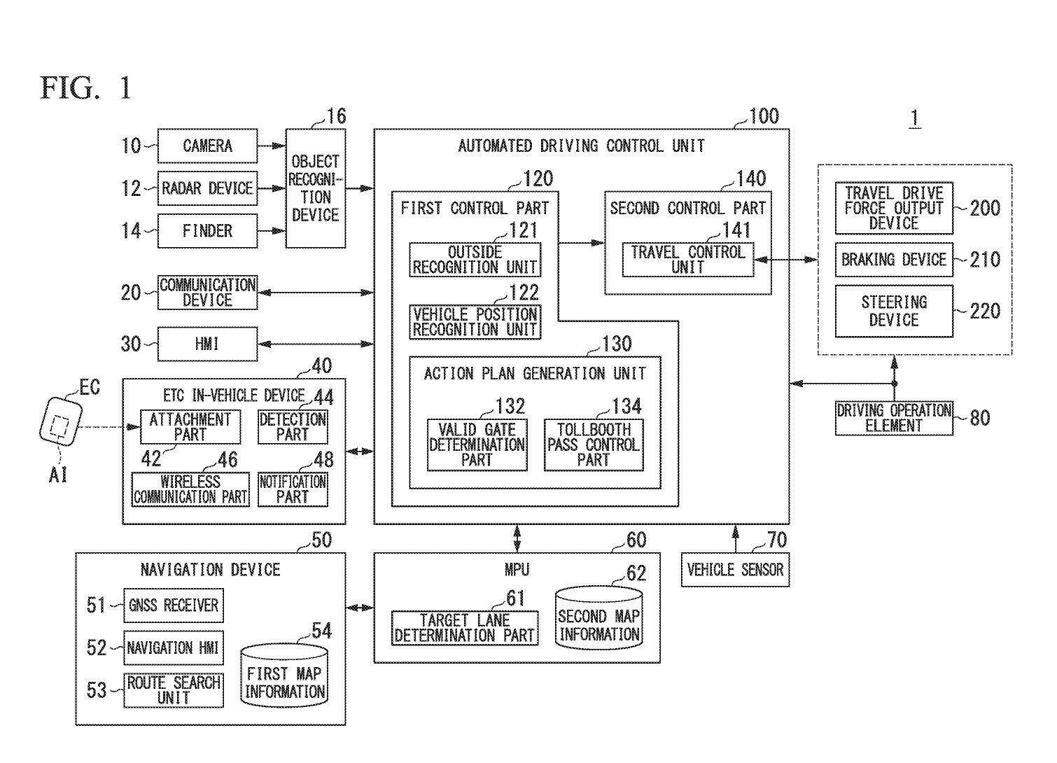

FIG. 1 is a configuration view of a vehicle system 1 that includes an automated driving control unit 100. A vehicle on which the vehicle system 1 is mounted is, for example, a vehicle having two wheels, three wheels, four wheels, or the like. A drive source of the vehicle on which the vehicle system 1 is mounted is an internal combustion engine such as a diesel engine and a gasoline engine, an electric motor, or the combination of the internal combustion engine and the electric motor. The electric motor is operated by using generated electric power by a generator that is connected to the internal combustion engine or discharged electric power of a secondary battery or a fuel cell.

The vehicle system 1 includes: for example, a camera 10; a radar device 12; a finder 14; an object recognition device 16; a communication device 20; a HMI (Human Machine Interface) 30; an ETC (Electronic Toll Collection system) in-vehicle device 40; a navigation device 50; a MPU (Micro-Processing Unit) 60; a vehicle sensor 70; a driving operation element 80; the automated driving control unit 100; a travel drive force output device 200; a braking device 210; and a steering device 220. The devices and equipment are mutually connected by a multiplex communication line such as a CAN (Controller Area Network) communication line, a serial communication line, a wireless communication network, and the like. The configuration shown in FIG. 1 is an example; part of the configuration may be omitted, and another configuration may be further added.

The camera 10 is, for example, a digital camera that uses a solid-state imaging element such as a CCD (Charge-Coupled Device) or a CMOS (Complementary Metal Oxide Semiconductor). One or a plurality of cameras 10 are attached to an arbitrary part of the vehicle (hereinafter, referred to as a vehicle M) on which the vehicle system 1 is mounted. When a frontward direction is imaged, the camera 10 is attached to an upper part of a front window shield, a rear surface of a room mirror, and the like. The camera 10, for example, periodically and repeatedly captures an image around the vehicle M. The camera 10 may be a stereo camera.

The radar device 12 radiates radio waves such as millimeter waves to the vicinity of the vehicle M, detects the radio waves (reflected waves) that are reflected by an object, and detects at least a position (distance and azimuth) of the object. One or a plurality of radar devices 12 are attached to an arbitrary part of the vehicle M. The radar device 12 may detect the position and the speed of an object by a FM-CW (Frequency Modulated Continuous Wave) method.

The finder 14 is a LIDAR (Light Detection and Ranging, or Laser Imaging Detection and Ranging) that measures scattered light with respect to irradiation light and that detects a distance to a target. One or a plurality of finders 14 are attached to an arbitrary part of the vehicle M.

The object recognition device 16 performs a sensor fusion process with respect to a detection result by part of or all of the camera 10, the radar device 12, and the finder 14 and recognizes the position, the category, the speed, and the like of the object. The object recognition device 16 outputs the recognition result to the automated driving control unit 100.

The communication device 20 communicates with another vehicle that is present around the vehicle M, for example, by using a cellular network, a Wi-Fi network, Bluetooth (registered trademark), DSRC (Dedicated Short Range Communication), and the like or communicates with a variety of server apparatuses via a wireless base station such as VICS (registered trademark).

The HMI 30 presents a variety of information to an occupant of the vehicle M and accepts an input operation by the occupant. The HMI 30 includes a variety of display devices, a speaker, a buzzer, a touch panel, a switch, a key, and the like. The operation part such as the touch panel, the switch, and the key in the HMI 30 functions as a reception part that receives an operation which switches the driving mode of the vehicle M to an automated driving mode. The automated driving mode is, for example, a driving mode that controls at least one of steering and acceleration/deceleration of the vehicle M and thereby causes the vehicle M to automatically travel along a route to a destination.

An ETC in-vehicle device 40 includes an attachment part 42 to which an ETC card (EC) is attached, a detection part 44 that detects whether or not an ETC card is attached to the attachment part 42, a wireless communication part 46 that communicates with an ETC roadside device which is provided on a gate of a toll road, and a notification part 48. The ETC card is a medium in which authentication information (AI) by which the vehicle M passes through a toll road is stored. The wireless communication part 46 may be shared with the communication device 20.

The attachment part 42 includes an insertion/extraction mechanism which the ETC card can be mounted to and be extracted from. The detection part 44 detects whether the attachment part 42 is in a state in which the ETC card is mounted or is in a state in which the ETC card is extracted. The detection part 44 outputs a detection result to the automated driving control unit 100. The detection part 44 may include a function part that detects the validity or the invalidity of the ETC card on the basis of the expiration date of the ETC card or the like. In this case, the detection part 44 may determine that the state is a state in which an ETC card is mounted when an ETC card is valid and determine that the state is a state in which an ETC card is not mounted when an ETC card is invalid.

The wireless communication part 46 transmits authentication information that is stored in the ETC card to the ETC roadside device in response to a request which is received from the ETC roadside device. The wireless communication part 46 acquires information of whether or not passing through the gate where the ETC roadside device is provided is permitted, an entrance tollbooth, an exit tollbooth, and the like on the basis of an authentication result that is received from the ETC roadside device. The ETC roadside device determines a billing amount with respect to the occupant of the vehicle M on the basis of information that is received from the ETC in-vehicle device and proceeds with a billing process.

The notification part 48 is a speaker that outputs speech, an indicator, and the like. The notification part 48 notifies the mounting state of the ETC card and the authentication result that is acquired by the wireless communication part 46 of the occupant.

The navigation device 50 includes, for example, a GNSS (Global Navigation Satellite System) receiver 51, a navigation HMI 52, and a route search unit 53. The navigation device 50 holds first map information 54 in a storage device such as a HDD (Hard Disk Drive) and a flash memory. The GNSS receiver 51 identifies the position of the vehicle M on the basis of a signal that is received from the GNSS satellite. The position of the vehicle M may be identified or supplemented by an INS (Inertial Navigation System) that utilizes an output of the vehicle sensor 70.

The navigation HMI 52 includes a display device, a speaker, a touch panel, a key, and the like. Part of or all of the navigation HMI 52 may be shared with the HMI 30 described above. The navigation HMI 52 accepts information of the destination and the like on the basis of the operation of the occupant.

For example, the route search unit 53 refers to the first map information 54 and determines a route from the position (or an input arbitrary position) of the vehicle M that is identified by the GNSS receiver 51 to a destination that is input by the occupant by using the navigation HMI 52. The route search unit 53 recalculates the route when the current position of the vehicle M is away from the searched route by a predetermined distance or more. The route that is determined by the route search unit 53 is output to the MPU 60. The navigation device 50 may prepare a route guide using the navigation HMI 52 on the basis of the route that is determined by the route search unit 53.

The first map information 54 is, for example, information in which a road shape is described by a link that indicates a road and a node that is connected by the link. The first map information 54 may include the curvature of a road, POI (Point-of-Interest) information, and the like.

The navigation device 50 may be realized by, for example, a function of a terminal apparatus such as a smartphone and a tablet terminal that is held by the user. The navigation device 50 may transmit a current position and a destination to a navigation server via the communication device 20 and may acquire a route which is returned from the navigation server.

The MPU 60 functions, for example, as a target lane determination part 61. The MPU 60 holds second map information 62 in a storage device such as a HDD and a flash memory. The target lane determination part 61 divides the route that is supplied from the navigation device 50 into a plurality of blocks (for example, divides at an interval of 100 [m] with respect to a vehicle proceeding direction) and determines a target lane for each block with reference to the second map information 62. The target lane determination part 61 determines, for example, which lane from the left the vehicle should travel on. When a branching point, a merging point, or the like is present on the route, the target lane determination part 61 determines a target lane such that the vehicle M can travel on a reasonable travel route for proceeding to a branch destination.

The second map information 62 is map information having higher accuracy than the first map information 54 in the navigation device 50. The second map information 62 includes, for example, information of the center of a lane, information of the boundary of a lane, or the like. The second map information 62 may include road information, traffic regulation information, address information (address and zip code), facility information, phone number information, and the like. The road information includes information that represents the class of a road such as a freeway, a toll road, a national road, or a prefectural road and information of the number of lanes of a road, the width of each lane, the gradient of a road, the position of a road (three-dimensional coordinate including the longitude, latitude, and height), the curvature of a curve of a lane, the position of merging and branching points of a lane, a sign provided on a road, and the like. The second map information 62 includes class information that represents which of an ETC gate, a general gate, and an ETC/general gate is the class of a gate in a toll road, position information of each gate, and the like. The second map information 62 may be updated as needed by accessing another apparatus using the communication device 20.

The vehicle sensor 70 includes a vehicle speed sensor that detects the speed of the vehicle M, an acceleration sensor that detects acceleration, a yaw rate sensor that detects an angular speed around a vertical axis, an azimuth sensor that detects the direction of the vehicle M, and the like.

The driving operation element 80 includes, for example, an accelerator pedal, a brake pedal, a shift lever, a steering wheel, and other operation elements. A sensor that detects the amount of operation or the presence or absence of operation is attached to the driving operation element 80. The detection result of the sensor of the driving operation element 80 is output to one or both of the automated driving control unit 100, and the travel drive force output device 200, the braking device 210, and the steering device 220.

The automated driving control unit 100 includes, for example, a first control part 120 and a second control part 140. Each of the first control part 120 and the second control part 140 is realized by executing a program (software) by a processor such as a CPU (Central Processing Unit). Part of or all of functional parts of the first control part 120 and the second control part 140 described below may be realized by hardware such as a LSI (Large-Scale Integration), an ASIC (Application-Specific Integrated Circuit), and a FPGA (Field-Programmable Gate Array) or may be realized by the cooperation of software and hardware.

The first control part 120 includes, for example, an outside recognition unit 121 (detection unit), a vehicle position recognition unit 122, and an action plan generation unit 130.

The outside recognition unit 121 recognizes the behavior of the position, speed, acceleration, and the like of a peripheral vehicle on the basis of information that is input via the object recognition device 16 from the camera 10, the radar device 12, and the finder 14. The position of a peripheral vehicle may be represented by a representative point such as a center of gravity or a corner of the peripheral vehicle or may be represented by a region that is described by the outline of the peripheral vehicle. The “behavior” of a peripheral vehicle may include the acceleration, jerk, or “action state” (for example, whether or not the peripheral vehicle is performing a lane change, or whether or not the peripheral vehicle will perform a lane change) of the peripheral vehicle. The outside recognition unit 121 may recognize positions of a guardrail, a power pole, a parked vehicle, a pedestrian, and other objects in addition to the peripheral vehicle.

The vehicle position recognition unit 122 recognizes, for example, the lane (travel lane) on which the vehicle M is travelling, and the relative position and attitude of the vehicle M with respect to the travel lane. The vehicle position recognition unit 122 recognizes the travel lane, for example, by comparing a pattern (for example, an arrangement of a solid line and a dashed line) of a road partition line that is obtained from the second map information 62 with a pattern of a road partition line around the vehicle M that is recognized from the image captured by the camera 10. The position of the vehicle M that is acquired from the navigation device 50 and the process result by the INS (Inertial Navigation System) may be additionally considered in this recognition.

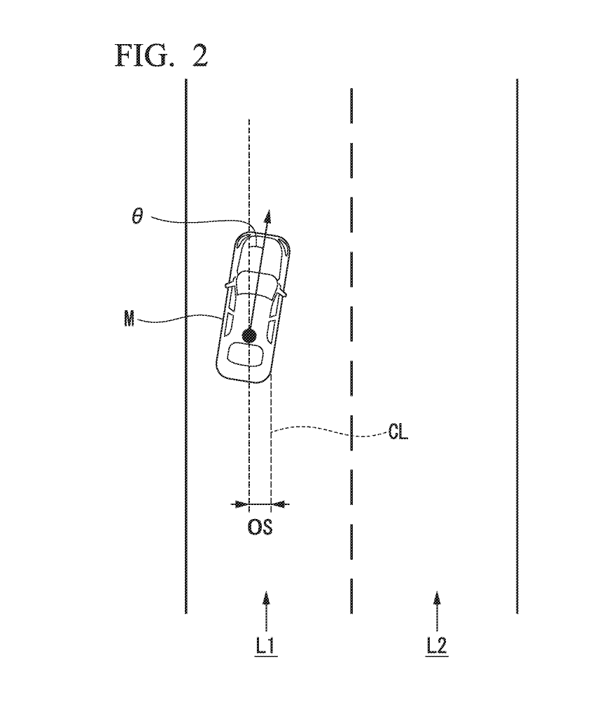

The vehicle position recognition unit 122 recognizes, for example, the position and the attitude of the vehicle M with respect to the travel lane. FIG. 2 is a view showing a state in which the relative position and the attitude of the vehicle M with respect to a travel lane L1 are recognized by the vehicle position recognition unit 122. The vehicle position recognition unit 122 recognizes, for example, as the relative position and the attitude of the vehicle M with respect to the travel lane L1, a gap OS of a reference point (for example, the center of gravity) of the vehicle M from a travel lane center CL and an angle θ that is formed by the proceeding direction of the vehicle M with respect to a line which is formed of continued travel lane centers CL. Alternatively, the vehicle position recognition unit 122 may recognize, as the relative position of the vehicle M with respect to the travel lane, the position of the reference point of the vehicle M with respect to any of side end parts of the lane L1 and the like. The relative position of the vehicle M that is recognized by the vehicle position recognition unit 122 is supplied to the target lane determination part 61 and the action plan generation unit 130.

The action plan generation unit 130 includes a valid gate determination part 132 (determination part) and a tollbooth pass control part 134 (control part). The action plan generation unit 130 determines events that are sequentially performed in automated driving so as to travel on the target lane that is determined by the target lane determination part 61 and so as to be capable of responding to peripheral circumstances of the vehicle M. Examples of the event include a constant speed travel event of traveling on the same travel lane at a constant speed, a follow-up travel event of following up a frontward traveling vehicle, a lane-change event, a merging event, a branching event, a tollbooth event, an emergency stop event, and a handover event for finishing automated driving and switching to manual driving. Further, an action for avoidance may be planned on the basis of peripheral circumstances (presence of a peripheral vehicle or a pedestrian, lane narrowing due to a roadwork, and the like) of the vehicle M while performing the events. The valid gate determination part 132 determines an operating gate (hereinafter, referred to as a valid gate) in the tollbooth event. In other words, the valid gate determination part 132 determines a closed gate (hereinafter, referred to as an invalid gate) that is not operating. The tollbooth pass control part 134 generates a target trajectory used for causing the vehicle M1 to pass through a valid gate that is determined by the valid gate determination part 132. The valid gate determination part 132 determines an operating gate with respect to a gate in a tollbooth; however, the gate is not limited to a gate in a tollbooth, and the valid gate determination part 132 may determine an operating gate with respect to a gate other than a gate in a tollbooth. Examples of a gate other than a gate in a tollbooth include a gate that monitors passing of a vehicle without requiring payment of a fee.

The tollbooth pass control part 134 generates a target trajectory on which the vehicle M will travel. The target trajectory is represented as a trajectory in which points (trajectory points) to be arrived at by the vehicle M are sequentially arranged. The trajectory point is a point to be arrived at by the vehicle M at each of predetermined travel distances. Additionally, a target speed and target acceleration at a predetermined sampling interval (for example, about several hundreds of milliseconds) are generated as part of the target trajectory. The trajectory point may be a position, of each of predetermined sampling times, to be arrived at by the vehicle M at the sampling time. In this case, the information of the target speed and target acceleration is represented by the interval of trajectory points.

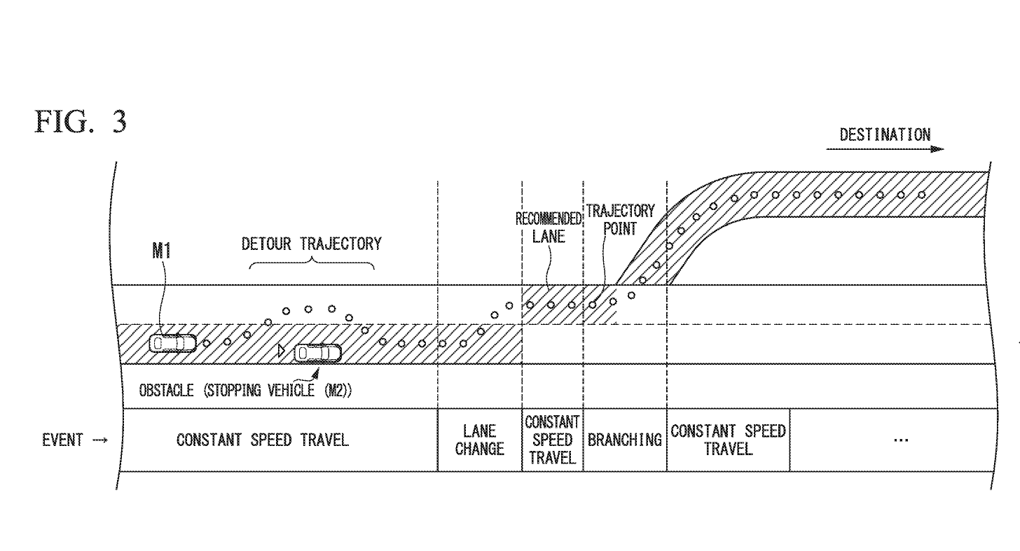

FIG. 3 is a view showing a state in which a target trajectory is generated on the basis of a target lane. As shown in the drawing, the target lane is set such that it is convenient to travel along a route to a destination.

When arriving at a position (the position may be determined corresponding to the category of an event) by a predetermined distance before a point at which the target lane is switched, the action plan generation unit 130 starts a lane-change event, a branching event, a merging event, a tollbooth event, and the like. When it becomes necessary to detour an obstacle while performing the events, a detour trajectory is generated as shown in the drawing. The tollbooth pass control part 134 generates, for example, a plurality of candidates of the target trajectory and selects an optimum target trajectory at that time point on the basis of safety and efficiency. In this way, the automated driving mode causes the vehicle M to travel along the route to the destination.

The second control part 140 includes a travel control unit 141. The travel control unit 141 controls the travel drive force output device 200, the braking device 210, and the steering device 220 such that the vehicle M passes through the target trajectory that is generated by the tollbooth pass control part 134 exactly at a scheduled time.

The travel drive force output device 200 outputs, to a drive wheel, a travel drive force (torque) by which the vehicle travels. The travel drive force output device 200 includes, for example, the combination of an internal combustion engine, an electric motor, a transmission, and the like and an ECU that controls the internal combustion engine, the electric motor, the transmission, and the like. The ECU controls the above configuration in accordance with information that is input from the travel control unit 141 or information that is input from the driving operation element 80.

The braking device 210 includes, for example, a brake caliper, a cylinder that transmits an oil pressure to the brake caliper, an electric motor that generates the oil pressure at the cylinder, and a brake ECU. The brake ECU controls the electric motor in accordance with the information that is input from the travel control unit 141 and outputs a braking torque corresponding to a braking operation to each wheel. The braking device 210 may include, as a backup, a mechanism that transmits, to the cylinder via a master cylinder, an oil pressure that is generated by an operation of the brake pedal which is included in the driving operation element 80. The braking device 210 is not limited to the configuration described above and may be an electronically-controlled hydraulic braking device that controls an actuator in accordance with the information which is input from the travel control unit 141 and that transmits the oil pressure of the master cylinder to the cylinder.

The steering device 220 includes, for example, a steering ECU and an electric motor.

The electric motor applies, for example, a force to a rack and pinion mechanism and changes the direction of a steering wheel. The steering ECU drives the electric motor and changes the direction of the steering wheel in accordance with the information that is input from the travel control unit 141 or the information that is input from the driving operation element 80.

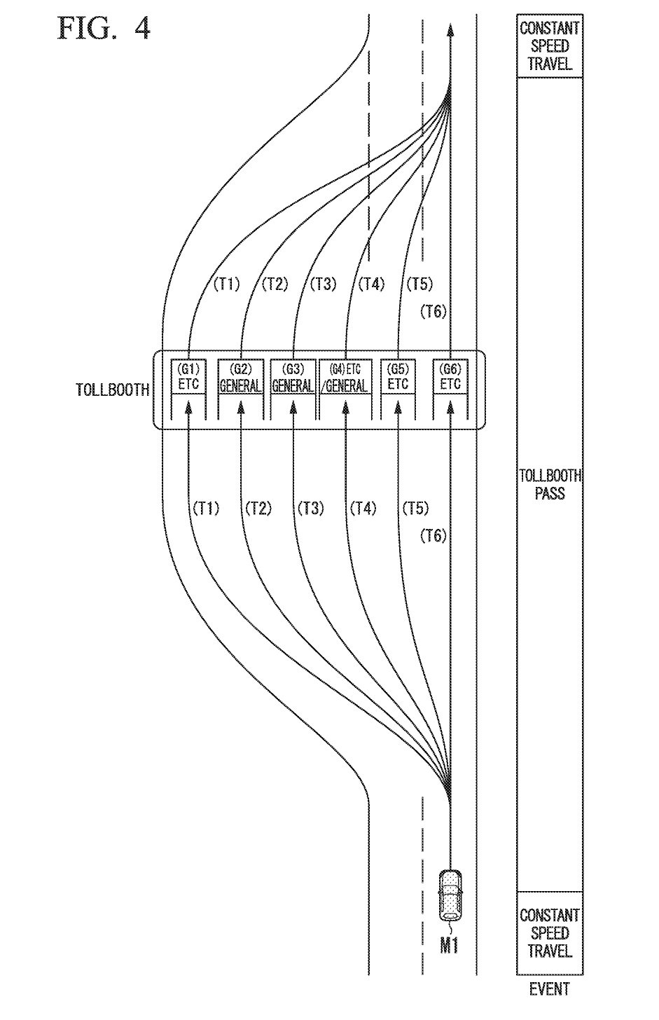

Hereinafter, the tollbooth event is described. FIG. 4 is a view showing a state in which a target trajectory is generated in a tollbooth event. When arriving at a position before a tollbooth by a predetermined distance, the action plan generation unit 130 starts a tollbooth event. The valid gate determination part 132 determines a target gate which is any of a plurality of gates that are provided in parallel in the route that is searched by the route search unit 53. The valid gate determination part 132 determines a target gate on the basis of the mounting state of the ETC card and from the viewpoint of safety such as the presence of another vehicle and efficiency such as a travel distance.

The plurality of gates that are provided in parallel is a set of gate groups that is built such that the vehicle M can travel selectively through a single gate. The set of gate groups includes an ETC gate at which it is determined whether or not the vehicle M is allowed to pass on the basis of authentication information that is stored in the ETC card, a general gate through which the vehicle M is allowed to pass with a requirement of receiving a ticket or manual payment, and an ETC/general gate having a function of both the ETC gate and the general gate.

The tollbooth pass control part 134 generates a target trajectory used for passing through a target gate that is determined by the valid gate determination part 132.

Hereinafter, a process is described in which the behavior of another vehicle in a region on which it is supposed that a vehicle travels in order to pass through a gate in a tollbooth is detected, and it is determined whether or not a gate is an operating gate on the basis of the detected behavior of the other vehicle.

The outside recognition unit 121 detects the behavior of another vehicle in a region on which it is supposed that a vehicle travels in order to pass through a gate in a tollbooth. The region on which it is supposed that a vehicle travels in order to pass through a gate in a tollbooth includes, for example, a road region from an end position P1 of a main road and a road region to a predetermined position P2 in the proceeding direction from a gate position. The end position P1 of a main road is, for example, a point at which the lane of the main road disappears. The predetermined position P2 in the proceeding direction from a gate position is a position at which it can be deemed that a vehicle has passed through a gate and is, for example, a position that is away from by about ten meters in the proceeding direction from the gate position. When another vehicle M2 has passed through a gate, the valid gate determination part 132 determines that the gate is a valid gate. When there is a gate through which another vehicle M2 does not pass, the valid gate determination part 132 determines that the gate is an invalid gate.

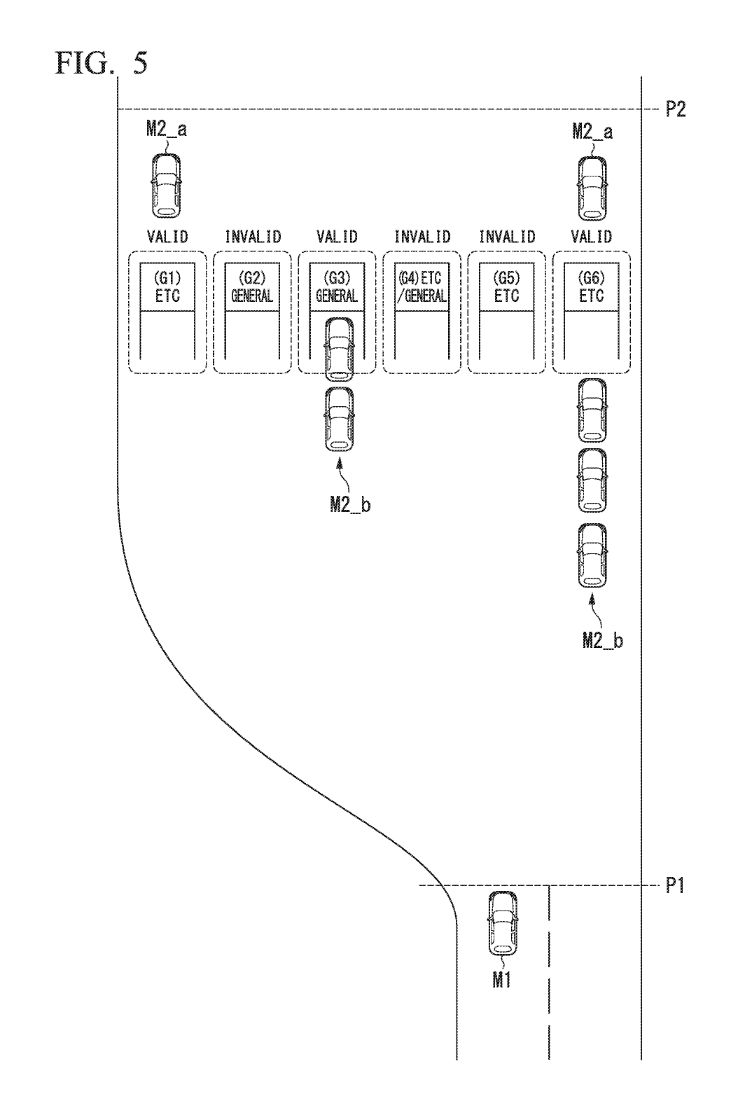

FIG. 5 is a view showing an example of a process in which a valid gate and an invalid gate are determined on the basis of the behavior of another vehicle M2. Specifically, it is assumed that the outside recognition unit 121 detects another vehicle M2_b that will enter a gate (G6) and another vehicle M2_a that has passed the gate (G6). In this case, the valid gate determination part 132 determines that the gate (G6) is a valid gate. It is assumed that the outside recognition unit 121 detects another vehicle M2_b that has passed the entrance of a gate (G3). In this case, the valid gate determination part 132 determines that the gate (G3) is a valid gate. It is assumed that the outside recognition unit 121 detects another vehicle M2_a that has passed a gate (G1). In this case, the valid gate determination part 132 determines that the gate (G1) is a valid gate.

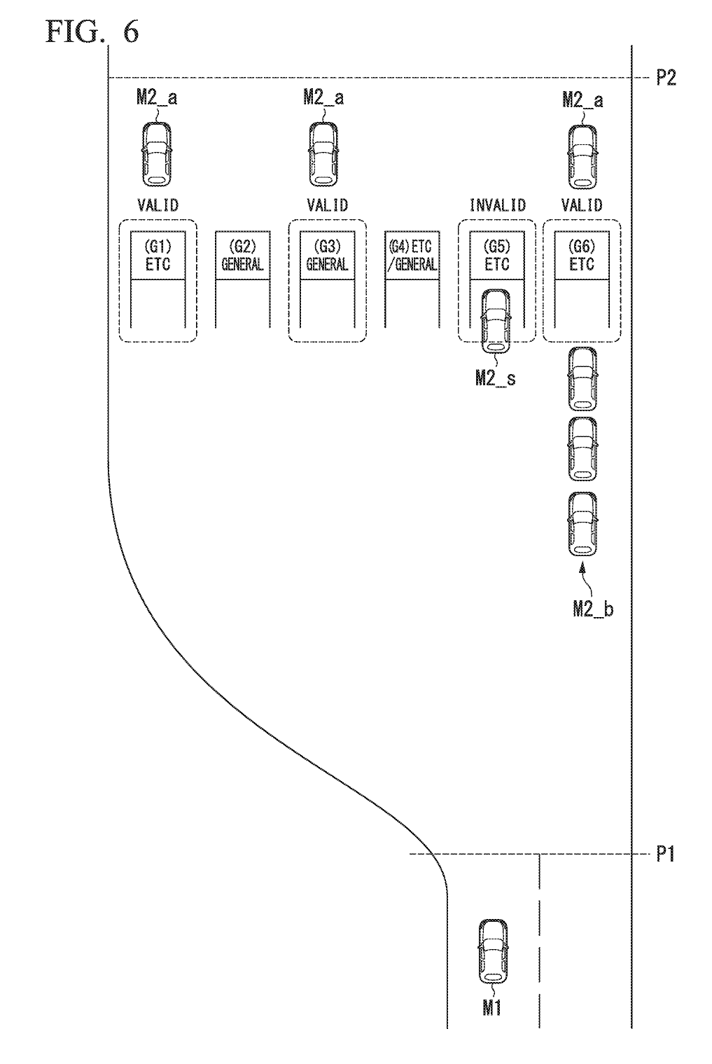

In a case where the vehicle speed when another vehicle M2 passes through a gate exceeds a predetermined value, the valid gate determination part 132 may determine that the gate is an operating gate. The predetermined value is, for example, 10 km/h. In a case where the vehicle speed when another vehicle M2 passes through a gate is equal to or less than a predetermined value, the valid gate determination part 132 may determine that the gate is not an operating gate. FIG. 6 is a view showing another example of a process in which a valid gate and an invalid gate are determined on the basis of the behavior of another vehicle M2. Specifically, it is assumed that the outside recognition unit 121 detects another vehicle M2_a that has passed through each of gates (G6), (G3), and (G1) at a vehicle speed that exceeds the predetermined value. In this case, the valid gate determination part 132 determines that the gates (G6), (G3), and (G1) are valid gates. It is assumed that the outside recognition unit 121 detects another vehicle M2_s that is stopping in a gate (G5). In this case, the valid gate determination part 132 determines that the gate (G5) is an invalid gate.

The valid gate determination part 132 may set a predetermined value of the vehicle speed by which whether or not an ETC gate is a valid gate is determined to be higher than a predetermined value of the vehicle speed by which whether or not a general gate is a valid gate is determined. When another vehicle M2 that is stopping in a general gate is present, the valid gate determination part 132 may determine whether or not a gate is a valid gate on the basis of the vehicle speed of other vehicles M2 excluding the stopping another vehicle M2.

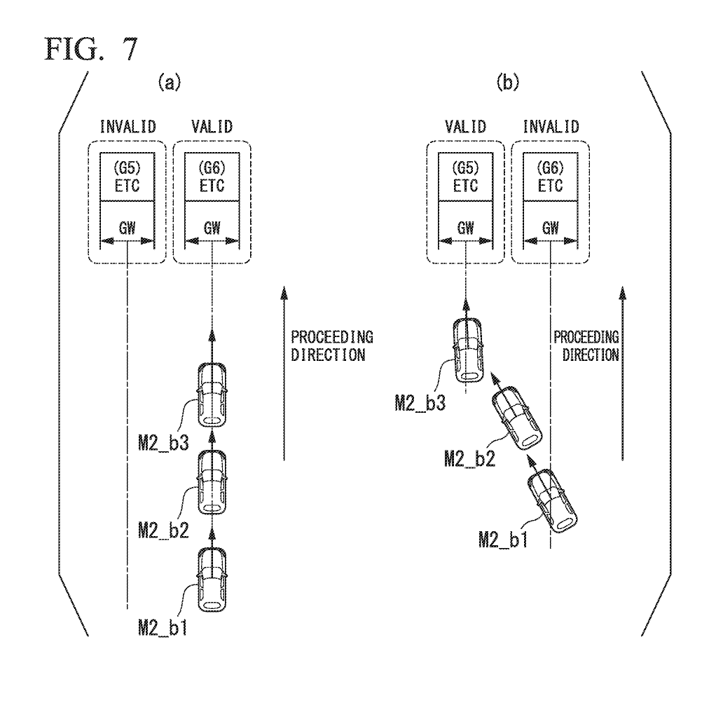

The valid gate determination part 132 may determine whether or not a gate is an operating gate on the basis of a position at which the behavior of another vehicle M2 is changed. FIG. 7 is a view showing another example of a process in which a valid gate and an invalid gate are determined on the basis of the behavior of another vehicle M2. Specifically, as shown in part (a) of FIG. 7, it is assumed that the outside recognition unit 121 detects that a gate (G6) is opposed to a plurality of other vehicles M2_b1, M2_b2, and M2_b3 in the vehicle proceeding direction. A gate being opposed to a vehicle is, for example, that when a line which extends in the vehicle proceeding direction is crossed at an angle close to an orthogonal angle with a line which extends in the direction of a gate width GW. In this case, as described above, on the basis of the behavior of another vehicle M2, the valid gate determination part 132 determines that the gate (G6) is a valid gate and determines that a gate (G5) is an invalid gate.

Then, as shown in part (b) of FIG. 7, it is assumed that the outside recognition unit 121 detects that the proceeding direction of the plurality of other vehicles M2_b1, M2_b2, and M2_b3 is changed toward a gate (G5) from the position that is opposed to the gate (G6). In this case, the valid gate determination part 132 determines that the position at which the plurality of other vehicles M2_b1, M2_b2, and M2_b3 change the proceeding direction is a position that is opposed to the gate (G6) and determines that the gate (G6) is an invalid gate.

It is assumed that the outside recognition unit 121 detects that the proceeding direction of the other vehicles M2_b1, M2_b2, and M2_b3 is changed from the gate (G6) to the gate (G5). In this case, the valid gate determination part 132 determines that the gate (G5) is a valid gate and determines that the gate (G6) is an invalid gate. When another vehicle M2_b3 of which the proceeding direction is changed is opposed to the gate (G5), the outside recognition unit 121 may determine that the gate (G5) is a valid gate and may determine that the gate (G6) is an invalid gate.

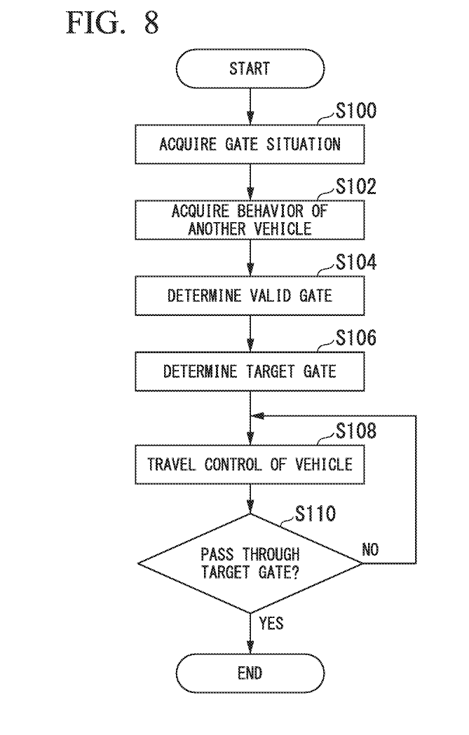

FIG. 8 is a flowchart showing the flow of a process that is performed in the tollbooth event.

The process of the present flowchart is performed when the tollbooth event is started. After the tollbooth event is started, the action plan generation unit 130 acquires a gate situation (Step S100). The action plan generation unit 130 acquires, as the current situation of a gate, information of the category of the gate and the position of each gate that is stored in the second map information 62 (Step S102). Next, the outside recognition unit 121 acquires the behavior of another vehicle (Step S102).

Next, the valid gate determination part 132 determines a valid gate (Step S104). The valid gate determination part 132 determines a valid gate with respect to each gate on the basis of at least one of whether or not another vehicle M2 passes, the vehicle speed when another vehicle M2 passes, and the change of the behavior of another vehicle M2. Next, the valid gate determination part 132 specifies a target gate which the vehicle M1 enters (Step S106). When it is determined that one gate is a valid gate in Step S104, the valid gate determination part 132 determines the one valid gate as a target gate. When it is determined that a plurality of gates are valid gates in Step S104, the valid gate determination part 132 determines one of the plurality of valid gates as a target gate on the basis of the mounting state of the ETC card and from the viewpoint of safety such as the presence of another vehicle and efficiency such as a travel distance.

Next, the tollbooth pass control part 134 generates a target trajectory from the position of the vehicle M to the position of the target gate, and the second control part 140 controls the travel of the vehicle M1 along the target trajectory (Step S108). The tollbooth pass control part 134 determines whether or not the vehicle M1 has passed through the target gate on the basis of the position of the vehicle M1 (Step S110). When the vehicle M1 has not passed through the target gate, the tollbooth pass control part 134 continues the travel control of the vehicle M1. When the vehicle M1 has passed through the target gate, the tollbooth pass control part 134 finishes the process of the present flowchart. The tollbooth pass control part 134 may repeat the processes of Step S102 to Step S106 and perform the travel control of the vehicle M1 until it is determined that the vehicle M1 has passed through the target gate. Thereby, the action plan generation unit 130 can flexibly change a valid gate on the basis of the behavior of another vehicle and the like.

As described above, according to the vehicle system 1 of the first embodiment, it is determined whether or not a gate is a valid gate on the basis of the behavior of another vehicle M2, and therefore, even in a case where, even when the state of the gate and the like is directly detected by the camera 10 of the vehicle M1 and the like, it is not possible to determine whether or not the gate is an operating gate, it is possible to determine an appropriate gate on the basis of the presence of another vehicle M2 around the vehicle M1. Further, according to the vehicle system 1 of the first embodiment, it is possible to prevent recognizing that a gate at which the number of other vehicles M2 is small is an operating gate, and therefore, it is possible to prevent causing the vehicle M1 to travel toward a gate which is not operating.

According to the vehicle system 1, when another vehicle M2 passes through a gate, it is determined that the gate is a valid gate, and therefore, it is possible to determine a gate that is actually operating as a valid gate.

According to the vehicle system 1, in a case where the vehicle speed when another vehicle M2 vehicle passes through a gate exceeds a predetermined value, it is determined that the gate is a valid gate, and therefore, it is possible to determine a gate through which another vehicle M2 has actually passed smoothly as a valid gate.

The vehicle system 1 determines a valid gate on the basis of the position at which the behavior of another vehicle M2 is changed, and therefore, it is possible to determine a gate to which the direction of another vehicle M2 is changed so as to actually pass through the tollbooth as a valid gate. Specifically, when another vehicle M2 makes a change from a first gate to a second gate, the vehicle system 1 can determine that the second gate is a valid gate and determine that the first gate is an invalid gate.

### Second Embodiment

Hereinafter, a second embodiment is described. A vehicle system 1A of the second embodiment is different from the vehicle system 1 of the first embodiment in that a virtual lane used for entering a gate is set at a position before the gate on the basis of the position of the gate, and it is determined whether or not the vehicle M1 can pass through the virtual lane and a gate that corresponds to the virtual lane on the basis of the behavior of another vehicle M2 in the set virtual lane. The difference is mainly described below.

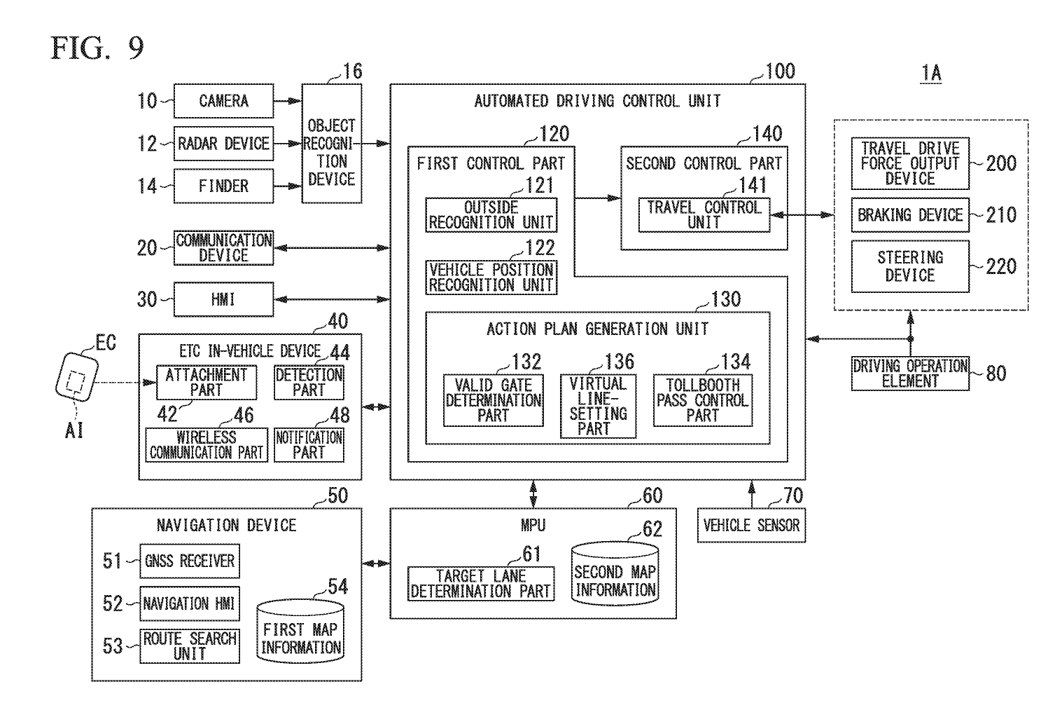

FIG. 9 is a configuration view of a vehicle system 1A of the second embodiment. The action plan generation unit 130 in the vehicle system 1A includes a virtual line-setting part 136 in addition to the valid gate determination part 132 and the tollbooth pass control part 134. The virtual line-setting part 136 sets a virtual line before a gate on the basis of the position of the gate. The valid gate determination part 132 determines whether or not the vehicle M1 can pass through the gate that corresponds to the virtual lane on the basis of the behavior of another vehicle M2 in the set virtual lane.

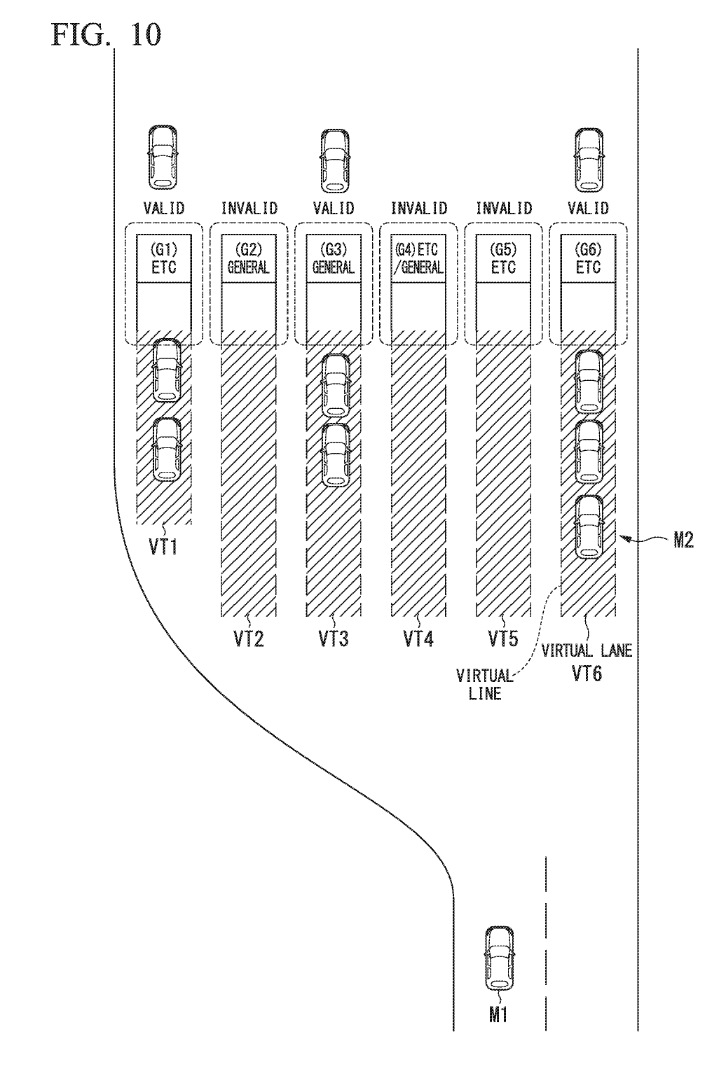

FIG. 10 is a view showing a virtual line being set for a gate in the second embodiment. For example, it is assumed that a vehicle travels from a closer side to a farther side than a position at which gates (G1) to (G6) are provided. The virtual line-setting part 136 causes a virtual line to extend to a closer side than the gate from each of two pole parts as a reference position of each gate. The position of the pole part of the gate may be information regarding the gate which is included in the second map information 62 and may be specified on the basis of an image that is captured by the camera 10 and the like. Thereby, the virtual line-setting part 136 sets two virtual lines with respect to each of the gates (G1) to (G6). The virtual line-setting part 136 sets a region that is interposed by two virtual lines as virtual lanes (VT1) to (VT6). In this example, two virtual lines are set; however, the embodiment is not limited thereto. A single virtual line may be caused to extend toward the vehicle M1 from the center position in the width direction of the gate, and a region having a predetermined width and having a virtual line as the center position may be set as a virtual lane.

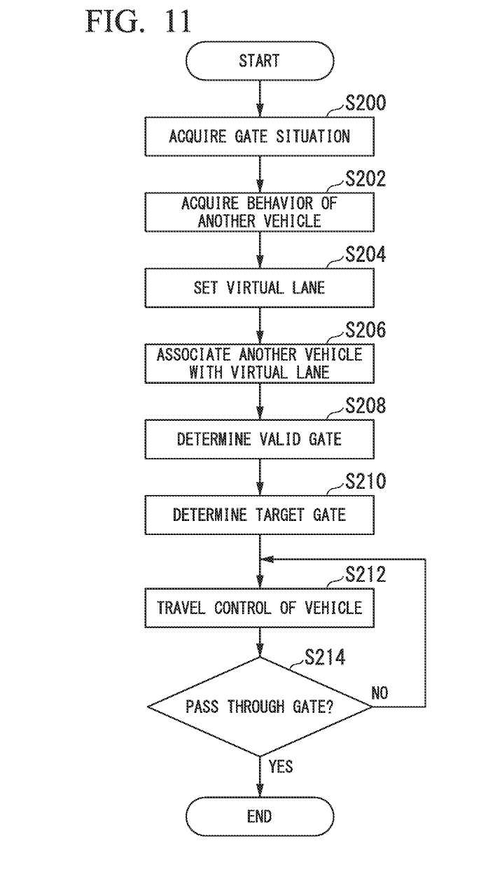

FIG. 11 is a flowchart showing the flow of a process that is performed in the tollbooth event in the second embodiment. The process of the present flowchart is performed when the tollbooth event is started. The action plan generation unit 130 acquires a gate situation after the tollbooth event is started (Step S200). The action plan generation unit 130 acquires, as the current situation of a gate, information of the category of the gate and the position of each gate that is stored in the second map information 62 and the like.

Next, the outside recognition unit 121 acquires the behavior of another vehicle (Step S202).

Next, the virtual line-setting part 136 sets a virtual lane (Step S204). Next, the valid gate determination part 132 associates another vehicle M2 with a virtual lane on the basis of the behavior of another vehicle M2 that is acquired in Step S202 and the virtual lane that is set in Step S204 (Step S206). When the position of another vehicle M2 is in a virtual lane, the valid gate determination part 132 associates the other vehicle M2 with the virtual lane.

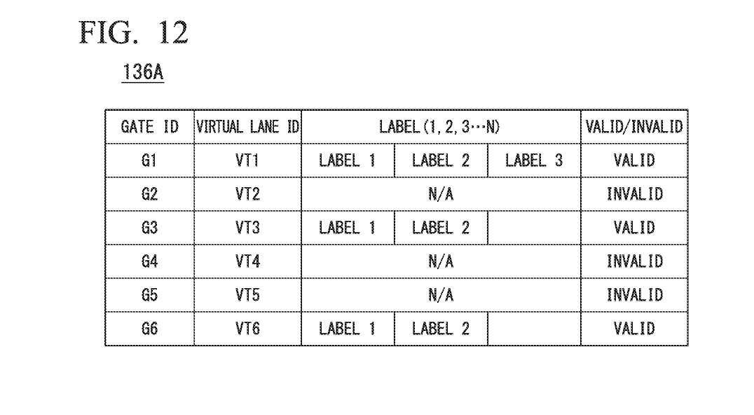

FIG. 12 is a view showing an example of a table 136A in the second embodiment. The table 136A is information in which a virtual lane, another vehicle, and information that represents whether or not a gate is a valid gate or is an invalid gate are associated with a gate ID. When the tollbooth event is started, the valid gate determination part 132 generates the table 136A. When the position of another vehicle M2 is present in the virtual lane, the valid gate determination part 132 registers a label that identifies another vehicle to the virtual lane ID. Thereby, the valid gate determination part 132 implements association between another vehicle M2 and the virtual lane.

The valid gate determination part 132 determines that a gate which corresponds to a gate ID of which the number of registered labels exceeds a predetermined number is a valid gate (Step S208). Next, the valid gate determination part 132 specifies a target gate which the vehicle M1 enters (Step S210). When it is determined that one gate is a valid gate in Step S208, the valid gate determination part 132 determines the one valid gate as a target gate. When it is determined that a plurality of gates are valid gates in Step S208, the valid gate determination part 132 determines one of the plurality of valid gates as a target gate on the basis of the mounting state of the ETC card and from the viewpoint of safety such as the presence of another vehicle and efficiency such as a travel distance.

The valid gate determination part 132 may repeatedly perform a labeling process that registers a label to a virtual lane at a predetermined time interval and may acquire a labeling result that is repeatedly acquired as a labeling result having a high degree of certainty. Thereby, the valid gate determination part 132 can further reliably determine a valid gate.

Next, the tollbooth pass control part 134 generates a target trajectory from the position of the vehicle M to the position of the target gate, and the second control part 140 controls the travel of the vehicle M1 along the target trajectory (Step S212). The tollbooth pass control part 134 determines whether or not the vehicle M1 has passed through the target gate on the basis of the position of the vehicle M1 (Step S214). When the vehicle M1 has not passed through the target gate, the tollbooth pass control part 134 continues the travel control of the vehicle M1. When the vehicle M1 has passed through the target gate, the tollbooth pass control part 134 finishes the process of the present flowchart. The tollbooth pass control part 134 may repeat the processes of Step S202 to Step S210 and perform the travel control of the vehicle M1 until it is determined that the vehicle M1 has passed through the target gate. Thereby, the action plan generation unit 130 can flexibly change a valid gate on the basis of the behavior of another vehicle and the like.

According to the vehicle system 1A of the second embodiment described above, it is determined whether or not a gate that corresponds to a virtual lane is an operating gate on the basis of the behavior of another vehicle in the virtual lane, and therefore, even when it is not possible to determine whether or not a gate is operating by the camera 10 of the vehicle M1 and the like, it is possible to determine whether or not the gate that is associated with the virtual lane is operating on the basis of the relationship between the virtual lane that is set closer to the vehicle M1 than the gate and the behavior of another vehicle M2. As a result, it is possible to determine a further appropriate gate.

### Third Embodiment

Hereinafter, a third embodiment is described. The third embodiment is different from the first and second embodiments described above in that the vehicle system 1 acquires a determination result which represents whether or not a gate is an operating gate from a traffic information management server and determines whether or not a gate is an operating gate on the basis of the acquired determination result. The difference is mainly described below.

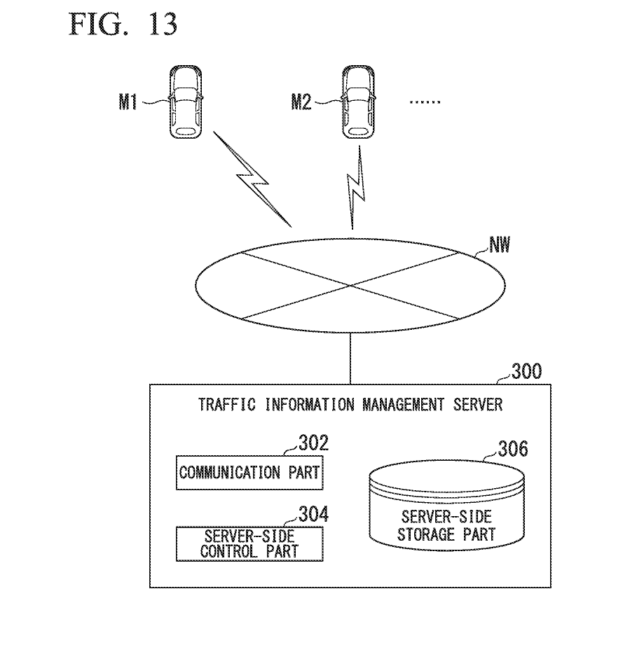

FIG. 13 is a view showing an example of a traffic information-providing system that includes the vehicle M1 on which the vehicle system 1 is mounted. The traffic information-providing system includes the vehicle M1, one or more other vehicles M2, and a traffic information management server 300. For example, at least a communication device that communicates with the traffic information management server 300 and a device that acquires a determination result which represents whether or not a gate is an operating gate are mounted on other vehicles M2. The determination result which represents whether or not a gate is an operating gate is information that is acquired by a function similar to the valid gate determination part 132 as described in the first and second embodiments; however, the determination result is not limited thereto. The determination result may be position information of a gate through which another vehicle M2 has actually passed or information such as an identification number of a gate. Another vehicle M2 transmits the determination result to the traffic information management server 300.

A communication is performed between the traffic information management server 300 and a vehicle that includes one or both of the vehicle M1 and another vehicle M2, for example, using a network NW. The network NW includes, for example, a cellular network, a Wi-Fi network, a WAN (Wide Area Network), a LAN (Local Area Network), the Internet, a dedicated line, a wireless base station, a provider, and the like.

The traffic information management server 300 is a server apparatus that manages information which is transmitted by a vehicle. The traffic information management server 300 includes, for example, a communication part 302, a server-side control part 304, and a server-side storage part 306. A processor executes a program, and thereby, the server-side control part 304 is realized. The server-side control part 304 may be realized by hardware such as a LSI and an ASIC or may be realized by the combination of software and hardware. The server-side storage part 306 is realized by a ROM, a RAM, a HDD, a flash memory, and the like.

The communication part 302 is a communication interface that communicates with the vehicle M1 and another vehicle M2. The server-side control part 304 stores a determination result that is received from another vehicle M2 in the server-side storage part 306. The server-side storage part 306 stores a database, for example, in which information that represents whether a gate is a valid gate or is an invalid gate is associated with the tollbooth ID and the gate ID. The server-side control part 304 updates the database in the server-side storage part 306 on the basis of the received determination result each timing when receiving a determination result from another vehicle M2. The server-side control part 304 transmits a determination result to the vehicle M1 using the communication part 302 in response to a request that is acquired from the vehicle M1.

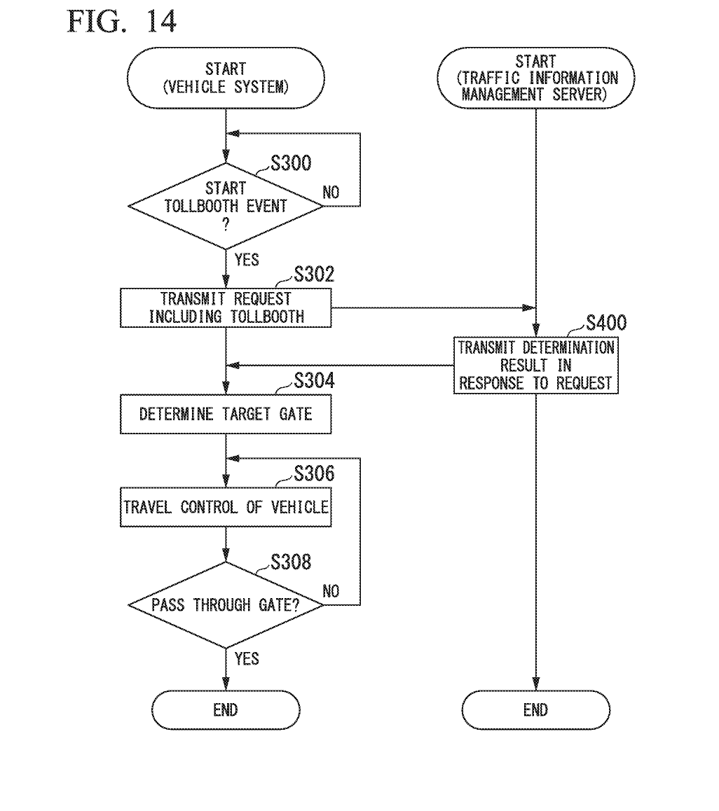

FIG. 14 is a flowchart showing the flow of a process that is performed by the vehicle system 1 and the traffic information management server 300.

The action plan generation unit 130 determines whether or not a tollbooth event is started (Step S300). The action plan generation unit 130 does not start the tollbooth event when the position of the vehicle M does not arrive at a position at which the tollbooth event is started. The action plan generation unit 130 starts the tollbooth event when the position of the vehicle M arrives at a position at which the tollbooth event is started.

When the tollbooth event is started, the action plan generation unit 130 transmits a request that includes information by which a tollbooth is specified to the traffic information management server 300 by using the communication device 20 (Step S302). The information by which a tollbooth is specified is an ID such as the name of a tollbooth that is stored in the first map information 54; however, the information is not limited thereto. The information by which a tollbooth is specified may be a travel direction and position of the vehicle M.

The traffic information management server 300 receives the request using the communication part 302. The server-side control part 304 refers to the database using the tollbooth that is designated by the request as a search key. The server-side control part 304 transmits a determination result of all of the gates in the designated tollbooth to the vehicle M1 (Step S400).

The vehicle system 1 receives the determination result by using the communication device 20. The valid gate determination part 132 specifies a target gate which the vehicle M1 enters (Step S304). When the determination result represents that one gate is a valid gate, the valid gate determination part 132 determines the one valid gate as a target gate. When it is determined that a plurality of gates are valid gates in the determination result, the valid gate determination part 132 determines one of the plurality of valid gates as a target gate on the basis of the mounting state of the ETC card and from the viewpoint of safety such as the presence of another vehicle and efficiency such as a travel distance.

Next, the action plan generation unit 130 generates a target trajectory from the position of the vehicle M to the position of the target gate, and the second control part 140 controls the travel of the vehicle M1 along the target trajectory (Step S306). The action plan generation unit 130 determines whether or not the vehicle M1 has passed through the target gate on the basis of the position of the vehicle M1 (Step S308). When the vehicle M1 has not passed through the target gate, the action plan generation unit 130 continues the travel control of the vehicle M1. When the vehicle M1 has passed through the target gate, the action plan generation unit 130 finishes the process of the present flowchart.

As described above, according to the vehicle system 1 of the third embodiment, it is possible to acquire a determination result which represents whether or not a gate is an operating gate from a traffic information management server and determine an appropriate gate on the basis of the acquired determination result.

The vehicle system 1 of the third embodiment determines whether or not a gate is a valid gate on the basis of the determination result that is acquired from another vehicle M2 via the traffic information management server; however, the embodiment is not limited thereto. The vehicle system 1 may acquire a determination result by an inter-vehicle communication. The vehicle system 1 acquires a determination result by an inter-vehicle communication from another vehicle M2 that has passed through a tollbooth through which the vehicle M1 will pass in the tollbooth event. Thereby, the vehicle system 1 can determine a further appropriate gate on the basis of the determination result that is acquired from another vehicle M2 which has actually passed through a gate.

Although embodiments of the invention have been described, the present invention is not limited to the embodiments, and a variety of changes and substitutions can be added without departing from the scope of the invention.

What is claimed is:

1. A vehicle control apparatus, comprising:
a detection part that detects a behavior of another vehicle in a region on which it is supposed that a vehicle travels in order to pass through a gate;
a determination part that determines whether or not a gate is an operating gate, based on the behavior of the other vehicle which is detected by the detection part; and
a control part that performs a vehicle control so as to pass through a gate which is determined as an operating gate by the determination part.

2. The vehicle control apparatus according to claim 1,
wherein when the other vehicle passes through a gate, the determination part determines that the gate is an operating gate, and when there is a gate through which the other vehicle does not pass, the determination part determines that the gate is not an operating gate.

3. The vehicle control apparatus according to claim 1,
wherein in a case where a vehicle speed when the other vehicle passes through a gate exceeds a predetermined value, the determination part determines that the gate is an operating gate, and in a case where a vehicle speed when the other vehicle passes through a gate is equal to or less than a predetermined value, the determination part determines that the gate is not an operating gate.

4. The vehicle control apparatus according to claim 2,
wherein the detection part detects that the other vehicle has passed through a gate, based on information that is detected by a sensor which is provided on the vehicle.

5. The vehicle control apparatus according to claim 1,
wherein the determination part determines whether or not a gate is an operating gate, based on a position at which the behavior of the other vehicle is changed.

6. The vehicle control apparatus according to claim 5,
wherein when a proceeding direction of the other vehicle is changed from a first gate to a second gate, the determination part determines that the second gate is an operating gate and determines that the first gate is not an operating gate.

7. The vehicle control apparatus according to claim 1, further comprising
a virtual line-setting part that sets a virtual lane used for entering the gate, based on a position of a gate, at a position before the gate, and
wherein the determination part determines whether or not a gate that corresponds to the virtual lane is an operating gate, based on a behavior of another vehicle in the virtual lane that is set by the virtual line-setting part.

8. The vehicle control apparatus according to claim 1,
wherein the detection part acquires a determination result that represents whether or not a gate is an operating gate from a server or another vehicle, and
the determination part determines whether or not a gate is an operating gate, based on the determination result that is acquired by the detection part.

9. A vehicle control method, comprising:
detecting a behavior of another vehicle in a region on which it is supposed that a vehicle travels in order to pass through a gate;
determining whether or not a gate is an operating gate, based on the behavior of the other vehicle; and
performing a vehicle control so as to pass through a gate which is determined as an operating gate.

10. A non-transitory computer-readable recording medium comprising a vehicle control program that causes a computer to:
detect a behavior of another vehicle in a region on which it is supposed that a vehicle travels in order to pass through a gate;
determine whether or not a gate is an operating gate, based on the behavior of the other vehicle; and
perform a vehicle control so as to pass through a gate which is determined as an operating gate.
